(19) United States
(12) Patent Application Publication
(10) Pub. No.: US 2018/0130184 A1
(43) Pub. Date: May 10, 2018

(54) METHOD FOR CLEARING OF VIRTUAL REPRESENTATATIONS OF OBJECTS

(71) Applicant: a.tron3d GmbH, Klagenfurt am Woerthersee (AT)

(72) Inventors: Juergen JESENKO, Riegersburg (AT); Engelbert KELZ, Klagenfurt (AT)

(21) Appl. No.: 15/783,148

(22) Filed: Oct. 13, 2017

(30) Foreign Application Priority Data
Oct. 13, 2016 (EP) 16 193 818.8

(51) Int. Cl. G06T 5/00; A61C 9/00; G06T 7/00

(52) U.S. Cl. CPC G06T 5/002; G06T 2207/30036; G06T 7/0012; A61C 9/0053

(57) ABSTRACT

Disclosed is a method for clearing, in particular for removing, unwanted data from optically detected virtual representations of objects, in particular teeth and intraoral structures. The method includes the following steps: a. Defining of an extension line of the representation; b. Stipulating of at least one optimization surface, which in at least one region has a consistent distance to the extension line; c. Securing an inner side and an outer side of the optimization surface; d. Determining of all elements of the representation outside of the outer side of the representation; and e. Removing of all elements outside of the representation.

The invention relates to a method for clearing, in particular for removing, unwanted data from optically detected virtual representations of objects, in particular teeth and intraoral structures.

Many systems for the optical detection of the three-dimensional geometry of objects are known in particular in the area of dental treatments. They are used in, for example, the production of prostheses, crowns, inlays or the like, serve for support in the monitoring of orthodontic treatments and/or quite generally help in the observation or detection of intraoral structures. On the one hand, the major advantage of these optical systems is that they are neither invasive nor unpleasant, such as, for example, the dental impression that is often used in conventional dentistry, nor do they constitute a potential risk to patients, as can be the case, for example, in radiation-based methods, such as the x-ray. On the other hand, the data are in electronic form after acquisition and can be easily stored, for example for later comparisons, or else transmitted, for example from a dentist to a dental laboratory.

One problem that arises constantly in optical methods for detection of the three-dimensional geometry of objects, in particular teeth, is that soft parts that are present in the oral cavity, such as the inside of the cheeks or the tongue, are unintentionally acquired. Later correction of these faulty recordings is usually difficult since even in systems that provide several pictures of the same region, the faulty pictures are included in the detected or computed geometry too and corrupt it. Furthermore, unintentionally photographed surfaces constitute an unnecessary additional data volume that under certain circumstances can slow various processes, such as, for example, the visualization of the detected surface geometry.

The approaches to this problem that have been undertaken so far in the state of the art follow mainly two basic strategies. In one strategy, the surfaces that have been defectively acquired are identified as such and removed. One example of this first approach is shown by WO 2013/010910 A1. In the second strategy, empty spaces are defined or identified in which there can be no surfaces, and surfaces in which it is consequently determined that they are located in these empty spaces are either removed by the system when identification takes place after measurement, or are ignored from the start. One example of this approach is disclosed in EP 2 775 256 A1.

It is common to the two systems that during or after scanning, either incorrectly detected surfaces or empty spaces must be actively acquired or recognized as faults; this, on the one hand, requires computer resources and, on the other hand, is susceptible to errors.

Therefore, the object of the invention is to overcome the above-described disadvantages and to make available a simplified method for clearing unwanted surface regions. Preferably, it should also be possible for it to be executed independently of a surface that has been detected at the instant of clearing. This means even without the fault being able to be referenced to an at least partially “finished” surface.

This object is achieved according to the invention by a method of the initially-described type, which is characterized in that the method includes the following steps:
a. Defining of an extension line of the representation,
b. Stipulating of at least one optimization surface, which in at least one region has a consistent distance to the extension line,
c. Securing an inner side and an outer side of the optimization surface,
d. Determining of all elements of the representation outside of the outer side of the representation,
e. Removing of all elements outside of the representation.

If the representation, for example, is a mandibular arch, the extension line which is defined in step a. essentially follows the mandibular arch. Possible ways to generate various exact extension lines are explained in later sections.

After all unwanted elements have been determined in steps b. to d., all points in space that correspond to the determined elements can be removed in step e accordingly. Subsequently, a cleared representation is obtained without incorrect or correct surfaces having had to be determined in a complicated method for this purpose.

Preferred embodiments of the invention are the subject matter of the dependent claims.

Preferred exemplary embodiments of the invention are described in more detail below using the drawings. Here:

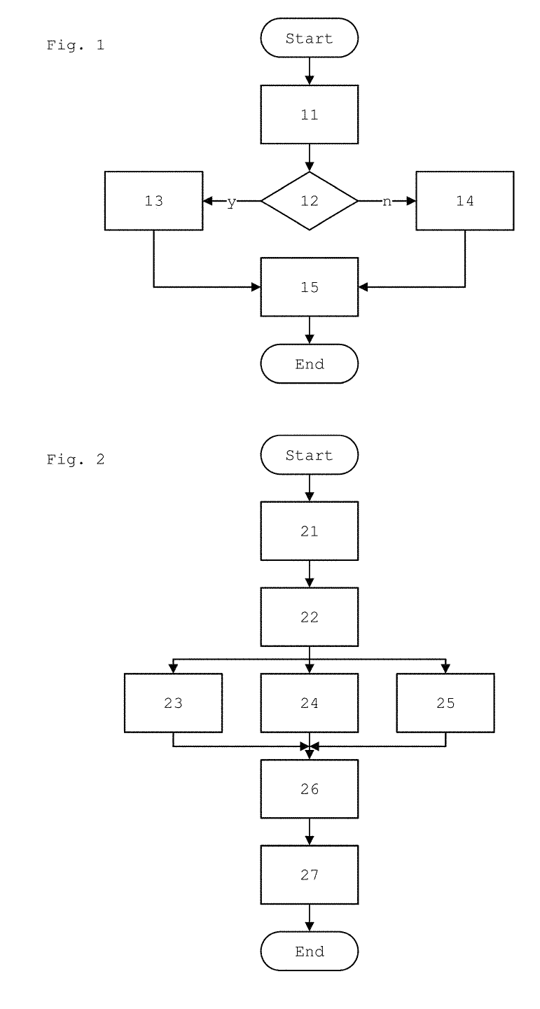

FIG. 1 shows a method for computational simplification of a three-dimensional representation, in particular of a TSDF,

FIG. 2 shows a method for determining principal axes,

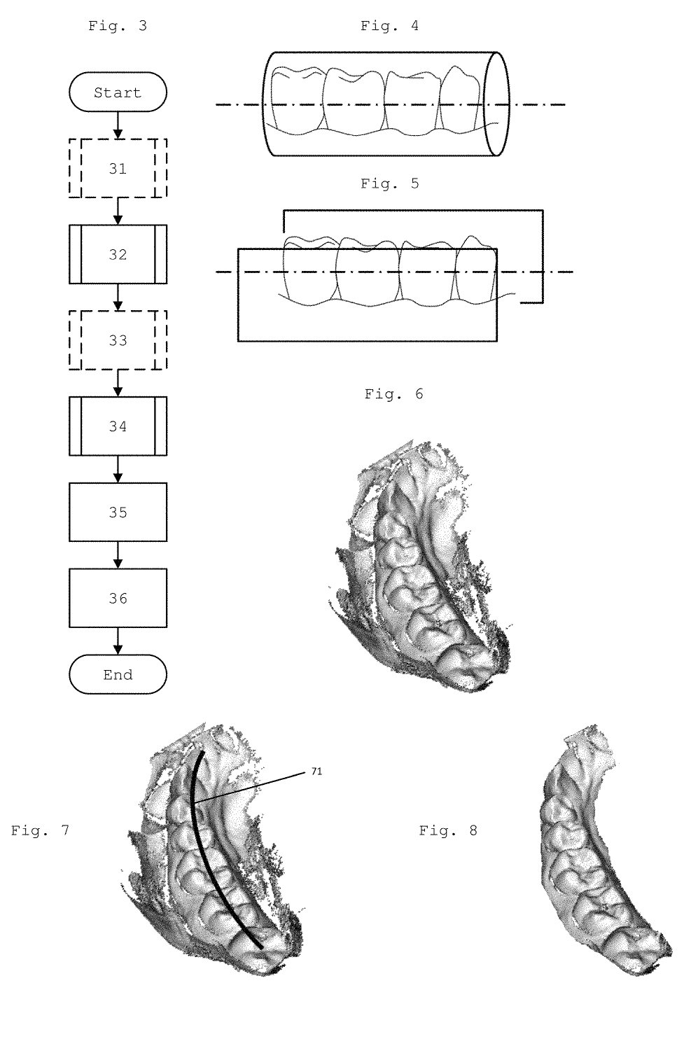

FIG. 3 shows by way of example a method according to the invention,

FIG. 4 shows—in highly schematized form—a first variant for an optimization surface,

FIG. 5 shows—in highly schematized form—a second variant for an optimization surface,

FIG. 6 shows by way of example the visualization of an optically detected jaw section,

FIG. 7 shows the exemplary visualization from FIG. 6 with one extension line,

FIG. 8 shows an exemplary visualization of a cleared representation that corresponds to FIGS. 6 and 7,

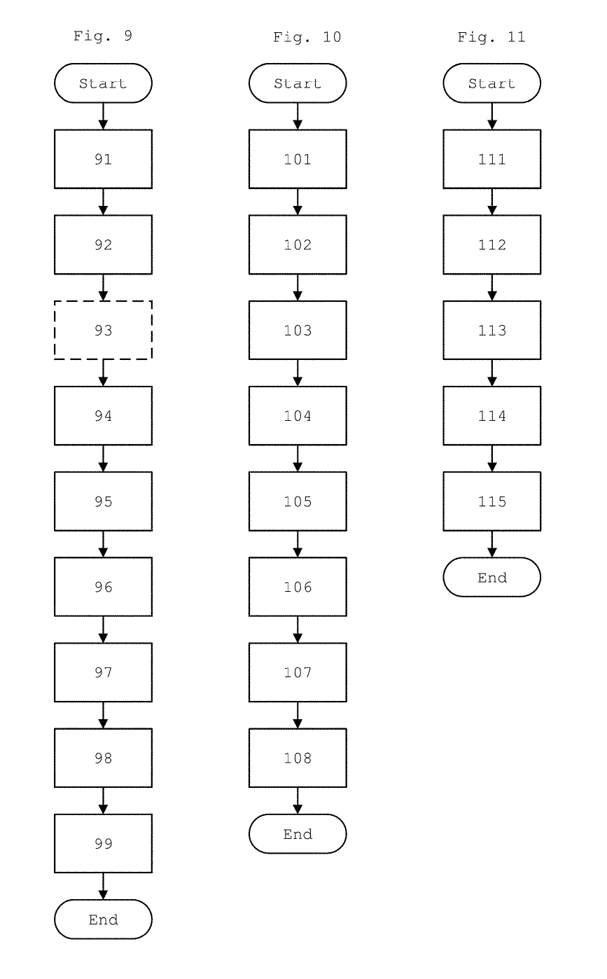

FIG. 9 shows one alternative method for arriving at an extension line,

FIG. 10 shows one alternative method for determining principal axes,

FIG. 11 shows another alternative method for generating an extension line,

FIG. 12 shows a highly simplified representation of steps 111 to 114 from FIG. 11,

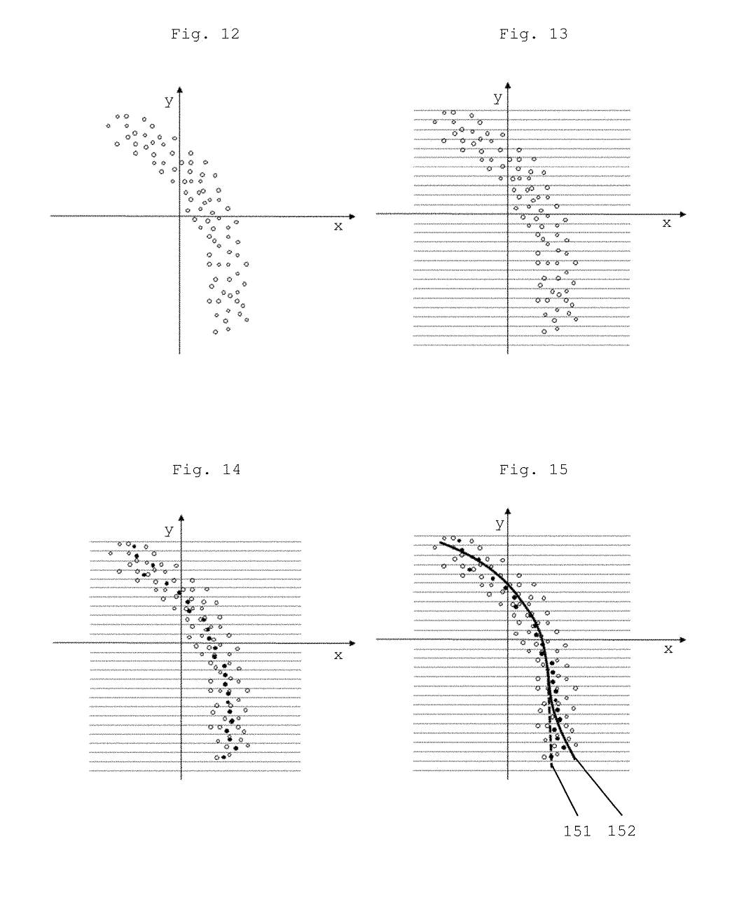

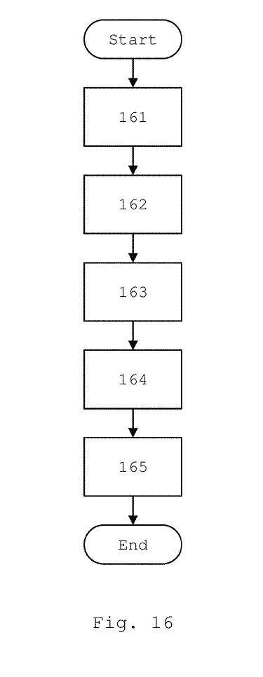

FIG. 13 shows a highly simplified representation of step 115 in FIG. 11,

FIG. 14 shows a highly simplified representation of steps 116 to 118 in FIG. 11, and

FIG. 15 shows a highly simplified representation of step 119 in FIG. 11 with one additional optional expansion of the method from FIG. 11,

FIG. 16 shows another alternative method for generating an extension line.

FIG. 1 shows a method for computational simplification of a three-dimensional representation, in particular of a TSDF. Here, a model to be cleared is first subdivided into coarser sections. For this purpose, groups of voxels are combined into so-called bricks in each case. A brick in this case is preferably a cube of n³ voxels, preferably 8³ voxels. The representation is subdivided in step 11.

Then, for each brick, the information as to whether the voxels of the brick contain surface information is retrieved (step 12).

If it is ascertained that at least one voxel of the brick contains surface information, a center point of the brick is notated as a location vector. Here, the location vector corresponds to a connection of an origin of a coordinate system, in which the TSDF is notated, to the center point of the brick (step 13).

If a brick does not contain any voxels that contain surface information, it is marked, for example, as “empty” (step 14).

Then, all empty bricks and location vectors are combined into a common point cloud. However, for each location vector, it is stored to which voxels it corresponds (step 15).

FIG. 2 shows a first possible method for determining the principal axes. To do this, first the covariance matrix of a point cloud is determined, in a step 21. This can be, for example, the simplified point cloud from the above-described steps 11 to 15. It is also possible, however, to work directly with a representation that is present in the form of a point cloud. In the subsequent step 22, the three eigenvectors of the covariance matrix from step 21 are determined. For three-dimensional point clouds, the covariance matrix will always deliver three eigenvectors. If the eigenvectors are determined, they are defined as the axial directions of a coordinate system. In a 3×3 covariance matrix, as it results from a three-dimensional point cloud, the axial directions are always orthogonal to one another, as in a Cartesian coordinate system. For the z-axis, the direction of the smallest eigenvector is selected (step 23). For the y-axis, for example, the direction of the largest eigenvector is selected (step 24). For the x-axis, for example, the middle eigenvector is selected (step 25). As is apparent to one skilled in the art, steps 23 to 25 can be executed in any sequence, or even in parallel, as shown in FIG. 2. Furthermore, in a step 26, the center of gravity of the point cloud is determined. It is then established in a step 27 as the origin of the coordinate system. Of course, the center of gravity can be determined independently of the other steps of the method shown in FIG. 2 (aside from step 27). With enough computing power, this step can proceed, for example, also in parallel to the other steps. The coordinate system that has been generated in this way with its principal axes with respect to the point cloud can be advantageously used in later steps of the method.

FIG. 3 shows an exemplary method according to the invention. For this purpose, in step 31, a virtual representation can be simplified first, as described for FIG. 1. This is not critically necessary for the invention, however. For example, in certain formats in which the representation can be present, this step can also be omitted. Steps that are self-evident, such as, for example, providing or loading the representation or such as the subsequent storing, are not individually cited or depicted for the sake of the clarity of the illustrated method. Corresponding steps before and after the actual method according to the invention can be chosen accordingly by one skilled in the art. The same also applies, of course, to the sequence of selected steps.

In the next step 32, an extension line for the representation is chosen. A highly simplified extension line is a straight line along the representation. One example of such a straight line can be the y-axis of the principal axes determined in FIG. 2, or the longest of the stipulated axes. Curved extension lines, however, can also be determined.

Examples for possible determination of curved extension lines are found in FIGS. 9 and 11, as well as in the explanatory FIGS. 12 to 15 for FIG. 9. One alternative method for determination of principal axes whose y-axis can be used as the extension line is shown in FIG. 10.

In a next, optional step 33, the extension line can optionally be smoothed. If the extension line is a straight line, this step is, of course, not necessary.

In a subsequent step 34, at least one optimization surface is generated along the extension line. Two preferred embodiments are a cylinder with the extension line as a center axis and parallel surfaces to the extension line.

In the variant in which the optimization surface is designed in the form of a cylinder, it is preferred when it is a cylinder with an elliptical base surface. In the case of curved extension lines, corresponding “hose-like” surfaces are also considered cylinders within the scope of the invention.

In the variants in which the optimization surfaces are parallel surfaces, parallel lines to the extension line are formed and are expanded into parallel surfaces in the direction of the z-axis.

Highly simplified, schematized depictions of the two variants are shown by FIG. 4 (cylindrical) and FIG. 5 (parallel surfaces).

In step 35, all points or voxels of the optionally simplified model that lie outside of the optimization surface(s) are marked. In this case, the side(s) of the optimization surface(s) that face the extension line are considered as “inner”, and the respective other side(s) that face away are considered as “outer”.

The distance(s) from the extension line are/is selected in such a way that between the inner surfaces or between the inner surfaces and the extension line, there is enough space that the model will not be corrupted. The distance can correspond in particular to half of the thickness up to the entire thickness of a molar, in particular ⅔ of the thickness of a molar. For this purpose, for example, a measured thickness can be used. However, if there are still too few data for such statements about the object that is to be measured, for example, statistical data can also be used in order to select a corresponding distance. However, a distance of 5 mm to 7 mm will usually be appropriate to the task.

In step 36, the points in space or data in the voxels of the TSDF that correspond to the points of the curve that were marked in the preceding step are then erased or set to “unknown” and thus are removed from the representation. With this, the clearing is completed. The process of marking a voxel as “unknown” or “unseen” is described in more detail in, for example, US 2015/0024337 A1.

FIGS. 6, 7, and 8 each show, by way of example, a visualization of the representation before clearing (FIG. 6), with a symbolically entered curved extension line 71 (FIG. 7), and after clearing (FIG. 8).

FIG. 9 shows a first method with which a curved extension line can be determined. In doing so, first a coordinate system is loaded in step 91. Methods for producing it are shown, for example, in FIGS. 2 and 12. In the following step 92, an extension projection plane is produced that is spanned between the x- and y-axis of the coordinate system. Optionally, in step 93, an extension projection region can now be defined. The simplest option here is just to project the complete model. In this case, the entire model is determined as a projection region. A second option is to project only half of the model, preferably that half in which the crowns of the teeth are located. The advantage here is that the shape of the mandibular arch emerges more distinctly in this way. In this case, for example, the half above or underneath the extension projection plane can be defined as a projection region. Another option is a slice shaped projection region, the boundaries of the slice being planes that are parallel to the extension projection plane and preferably having only a short distance to one another. Here, too, the advantage is that the shape of the dental arch can be especially easily recognized.

After the projection region has been defined, in step 94, all points of the projection region are projected vertically (therefore following the z-axis of the coordinate system) onto the extension projection plane. This yields a 2D point cloud, which is shown symbolically and highly schematically in FIG. 12. In step 95, this point cloud is then subdivided into equally large strips that each run parallel to the x-axis (FIG. 13).

Within each strip, in step 96, the largest and the smallest x-values are then determined, and in step 97, the arithmetic mean is formed. From the arithmetic mean from step 97 and the center of the strip on the y-axis, in step 98, a point that is assigned to one strip at a time and that is shown black in FIG. 14 is then determined for each strip.

If, for example, as a result of gaps in the measurement and/or the projection, a strip does not contain any points, this strip is ignored in the following steps.

Then, in step 99, a curve can be determined from the points from step 98. One especially suitable and preferred method for this purpose is the method of least squares. Other approximation methods can also be used, however. One possible approximated curve 152 that originated according to the method shown in FIG. 9 is shown by FIG. 15.

Furthermore, FIG. 15 illustrates an optional amelioration of the method from FIG. 9.

It has been shown that an approximation to a third-degree polynomial fits especially well to the shape of a dental arch in the anterior region (incisors) of said arch. However, in the posterior region (thus in the direction of the molars) the curve deviates farther from the shape of the mandibular arch than a simple straight extension line. In order to maintain the advantages of the good approximation of the polynomial in the anterior region and to still avoid the major deviation in the posterior region, in an advanced embodiment of the method from FIG. 9, a combined extension line is formed. To do this, first a third-degree polynomial is produced in the manner described in connection with FIG. 9. Then, the inflection point and the inflection tangent of the polynomial are determined. Then, in the anterior region, the polynomial is stipulated as the extension line, and starting at the inflection point the inflection tangent is stipulated as extension line. One such alternative course of the extension line is illustrated by the broken line 151 in FIG. 15. Of course, this advanced embodiment can also be applied to other methods for determining a curved extension line in which a third-degree polynomial is determined in order to approximate the shape of the dental arch. These fundamental explanations also apply to the method that is shown in FIG. 16.

FIG. 10 shows the course of one alternative method for producing principal axes that can take place in step 32. To do so, first the normal vectors of the surface of the representation are determined in a step 101. For this purpose, if the representation is in this notation, the TSDF can be used. If the notation as shown in FIG. 1 has been simplified, the normal vector for each voxel of the brick containing one surface is determined, and then an average normal vector is generated by all normal vectors being vector-added and the resulting vector then being brought again to length 1. The resulting vector is then defined as the normal vector of the brick.

In the subsequent step 102, the normal vectors from step 101 are projected onto a unit sphere (Gaussian projection). The origin of the coordinate system in which the representation or its simplification is notated can be used as the center point of the unit sphere. Alternatively, the center of gravity of the representation can be used. Both variants are covered, for example, at the same time when the coordinate system, in which the representation or its simplification is notated, has been produced according to the method that is shown in FIG. 2.

The Gaussian image that has been formed in step 102 can then be examined for free surfaces in the following step 103. In doing so, it is assumed that even if the model has gaps in which no data could have been acquired, in any case no data can be acquired in the region of the jawbone itself. Therefore to identify a larger region in which nothing has been imaged on the sphere at the same time means to identify the jaw or the “origin” of the represented tooth. If then in step 104, a center of this region is determined and then in step 105 a connection is drawn from the center point of the sphere to the center point of the region, it can be assumed that this connection corresponds essentially to the alignment of the represented teeth. Consequently, the connection that was generated in step 105 is stipulated as the direction of the z-axis. In this way, an optimum alignment of the representation to the coordinate system is effected.

One method for determining the (approximate) center of the empty region in step 104 could, for example, consist in that first the center of gravity of all imaged points on the Gaussian sphere is determined. This center of gravity of the imaged points on the Gaussian sphere is then offset somewhat from the center point and will be exactly opposite the empty region. If then a connection is drawn from the center of gravity of the imaged points on the Gaussian sphere to the center point, it points automatically in the direction of the center of the empty region. It must then only still be set to length 1 (while retaining the direction), and the above-described vector that is then stipulated as the z-axis in step 105 is obtained.

In a step 106, first the largest eigenvector of the representation is determined for the determination of the other axes of the coordinate system. It will generally not be orthogonal to the above-defined z-axis and is therefore not suited to be used itself as the axis. Therefore, in step 107, first of all a first cross-product of the largest eigenvector and the z-axis is determined. The direction of the resulting vector is then defined as the direction of the x-axis. To form the direction of the y-axis, in step 108, the cross-product of the defined z-axis from step 105 and the defined x-axis from step 107 is then simply formed.

Alternatively, in step 108, the cross-product of the x-axis that was formed in step 107 and the largest eigenvector that was determined in step 106 can be formed in order to determine a new z-axis. The largest eigenvector is then preserved as the y-axis.

The method shown in FIG. 11 constitutes one further alternative and advantageous method for deriving an extension line in step 32 (FIG. 3). To do this, in a step 111, first a (possibly simplified) representation that already has a centered and aligned coordinate system is loaded. Possible paths for producing such a coordinate system are shown by the methods in FIGS. 2 and 10. Likewise, in this method, in a step 112, an extension projection plane is then spanned between the x- and the y-axis. In the following step 113, the entire representation is imaged orthogonally onto the extension projection plane. Then, in step 114, the method of least squares is applied to the thus resulting two-dimensional point cloud, and the curve resulting from it is notated. The curve that has been stipulated in step 114 is then defined in a last step 115 as an extension line.

The advanced embodiment, which was explained for FIGS. 9 and 15 for curves that were approximated as a third-degree polynomial, can likewise be used for the method from FIG. 11, in which starting from the inflection point the inflection tangent is also stipulated as the extension line.

FIG. 16 shows another alternative method for arriving at an extension line. In a step 161, first a (possibly simplified) representation, which already has a centered and aligned coordinate system, is loaded. Possible ways to produce such a coordinate system, or to generate the principal axes of a coordinate system, are shown by the methods in FIGS. 2 and 10. One possible way to simplify the representation is shown in FIG. 1.

Then, in a step 162, so-called features within the representation are determined. Features are characteristics that stand out in the surface topography of the representation. They can be, for example, edges and in particular peaks, corners or even depressions of the model. Features are generally determined by identifying extreme changes in the surface curvature. To do this, all points of the model and their spatial relationship to adjacent points are examined individually. If all direct neighbors of a point lie essentially in one plane, the point also lies in one plane. If all neighbors of a point lie essentially in two planes, the point lies on an edge. If the neighbors of a point lie in three or more planes, the point lies on a peak or depression. The manner in which the features are determined is irrelevant to the invention. By way of example, but not limiting, the following methods known from the state of the art are mentioned at this point: “Harris Feature Detector”, CenSurE (“Centre Surround Extremas”), ISS (“Intrinsic Shape Signatures”), NARF (“Normal Aligned Radial Feature”), SIFT (“Scale Invariant Feature Transform”), SUSAN (“Smallest Univalue Segment Assimilating Nucleus”), and AGAST (“Adaptive and Generic Accelerated Segment Test”).

If the represented objects are teeth, the features can be, for example, protuberances, tips and/or fissures. Aside from teeth with an unusual malposition, it can usually be assumed that these features follow essentially the mandibular arch. They can therefore be used especially advantageously for construction of an extension line.

Analogously to the method that is shown in FIG. 9, in a step 163, an extension projection plane is then spanned between the x- and the y-axis. Of course, this can also take place even before the determination of the features in step 162. One skilled in the art can freely select the sequence of steps 162 and 163 without adversely affecting the function of the method.

In step 164, the determined features of the representation are projected orthogonally, viz. along the z-axis, into the extension projection plane. As also already described for FIG. 9, a two-dimensional point cloud is also formed in this method. However, the two-dimensional point cloud in this case has far fewer elements; this greatly simplifies further computations based on this point cloud and can render the intermediate steps in which strips and centers of gravity of the strips are produced superfluous. Furthermore, with this special two-dimensional point cloud, an especially precise basis for further computations is made available, since features in dental applications can occur only very improbably in regions of the representation that are not part of the teeth (or objects that are modeled after teeth are located accordingly likewise along the mandibular arch).

The two-dimensional point cloud that was generated in step 164 can then be used as a basis for an extension line. In step 165, the latter can be produced, for example, by the application of the Least Squares Method to the points. As already explained for FIG. 9 and as illustrated in FIG. 15, an especially good approximation to a mandibular arch can be achieved especially well by a third-degree polynomial that follows an inflection tangent starting from its inflection point.

In general, the described technology can be used both after scanning and also during scanning. If the latter should be desired, for example, an image (clone) of the representation can be produced, processed in parallel to detection and can be joined together with the representation that is just being detected at a later time. A method that is suitable for this purpose is shown, for example, by the Austrian utility model with application number GM 50210/2016.

### LABELING OF THE FIGURES

FIG. 1
11 Breaking down the model into bricks
12 Voxels in bricks contain surface information?
13 Determining of a common location vector for all voxels of the brick
14 Marking of the brick as “empty”
15 Joining all location vectors and empty bricks together into a simplified point cloud

FIG. 2
21 Determining the covariance matrix of the point cloud from steps 11 to 15 (FIG. 1) or step 31 (FIG. 3)
22 Determination of the three eigenvectors of the covariance matrix from step 21
23 Defining the smallest eigenvector as the direction of the z-axis
24 Defining the largest eigenvector as the direction of the y-axis
25 Defining the middle eigenvector as the direction of the x-axis
26 Determining the center of gravity of the point cloud
27 Defining the center of gravity as the origin of a coordinate system with the axes from steps 23, 24 and 25

FIG. 3
31 (optional) Simplifying the model (see steps 11 to 15 from FIG. 1)
32 Determining an extension line (for example, the y-axis of the principal axes, see steps 21 to 27 from FIG. 2 or steps 121 to 128 from FIG. 12; or a curved extension line, see steps 111 to 119 from FIG. 11 or steps 131 to 135 from FIG. 13)
33 (optional) Optimization of the extension line
34 Generation of the optimization surface(s)
35 Marking of the points in space or voxels of the model outside of the optimization surface(s)
36 Removal of the marked points in space or voxels (in step 35)

FIG. 7
71 A symbolic, curved extension line

FIG. 9
91 Loading of the representation with a coordinate system (see FIG. 2 or FIG. 12)
92 Spanning of an extension projection plane that is spanned from the x- and y-axis of the coordinate system
93 (optional) Defining an extension projection region
94 Projecting the points of the extension projection region onto the extension projection plane and generating a 2D point cloud
95 Breaking down the 2D point cloud from step 114 into strips
96 Determining the respective largest and smallest x-values per strip from step 115
97 Formatting the arithmetic mean of the two values from step 116 for each strip from step 115
98 Generating one point per strip from step 115 with the arithmetic mean from step 117 and the center of the strip on the y-axis
99 Creating a curve that is defined as an extension line from the points of step 118

FIG. 10
101 Making available a vector representation, for example from the method from FIG. 1
102 Projecting the vectors of the representation from step 121 onto a unit sphere (Gaussian imaging)
103 Checking of the sphere for a larger free region (without projected vectors)
104 Determining a center point of the region from step 123
105 Defining the direction of the z-axis of the coordinate system as the direction of the connection from the center point of the unit sphere to the center point of the region from step 124
106 Determining the largest eigenvector of the representation
107 Formatting a first cross-product of the z-axis from step 125 and of the largest eigenvector from step 127 and defining the first cross-product as the x-axis
108 Formatting a second cross-product from the z-axis and x-axis and defining the second cross-product as the y-axis

FIG. 11
111 Loading of the representation with a coordinate system (see FIG. 2 or FIG. 12)
112 Spanning of an extension projection plane between the x- and y-axis of the coordinate system
113 Orthogonal mapping of all points of the (if applicable simplified) representation on the extension projection plane
114 Applying the method of least squares to the mapping from step 133 and notating of the resulting curve
115 Defining the curve from step 134 as an extension line

FIG. 15
151 Extension line approximated as a third-degree polynomial
152 Alternative course of the extension line starting from the inflection point according to the inflection tangent of the polynomial 151

FIG. 16
161 Loading the (if applicable simplified) representation
162 Determining of features
163 Generating an extension projection plane
164 Formatting a two-dimensional point cloud by projecting the features from step 162 orthogonally onto the extension projection plane from step 163
165 Formatting of a graph along the two-dimensional point cloud from step 164

1. Method for clearing, in particular for removing, unwanted data from optically detected virtual representations of objects, in particular teeth and intraoral structures, wherein the method includes the following steps:
a. Defining an extension line of the representation,
b. Stipulating of at least one optimization surface, which in at least one region has a consistent distance to the extension line,
c. Securing an inner side and an outer side of the optimization surface,
d. Determining of all elements of the representation outside of the outer side of the representation,
e. Removing of all elements outside of the representation.

2. Method according to claim 1, wherein the optimization surface is a cylinder around the extension line.

3. Method according to claim 2, wherein the cylinder has an elliptical base surface, whose center point is the extension line.

4. Method according to claim 1, wherein the optimization surfaces are parallel surfaces to the extension line.

5. Method according to claim 1, wherein the defining of the extension line in step a. contains the following steps:
i. Determining of the eigenvectors of the representation,
ii. Defining of the longest eigenvector as the direction of the extension line,
iii. Defining of the length of the representation along the longest eigenvector as the length of the extension line.

6. Method according to claim 1, wherein the defining of the extension line in step a. contains the following steps:
a.i. Determining of features in the representation,
a.ii. Generating of a two-dimensional point cloud by projecting of points, on which features are located, onto an extension projection plane,
a.iii. Forming of a graph that runs along the point cloud generated in a.ii.,
a.iv. Defining the graph generated in a.iii. as an extension line.

7. Method according to claim 1, wherein the virtual representation is a TSDF.

8. Method according to claim 1, wherein the represented objects are teeth and wherein the representation depicts at least two, succeeding teeth.

9. Method according to claim 1, wherein that the extension line is a sequence of interconnected straight lines.

10. Method according to claim 2, wherein the defining of the extension line in step a. contains the following steps:
i. Determining of the eigenvectors of the representation,
ii. Defining of the longest eigenvector as the direction of the extension line,
iii. Defining of the length of the representation along the longest eigenvector as the length of the extension line.

11. Method according to claim 3, wherein the defining of the extension line in step a. contains the following steps:
i. Determining of the eigenvectors of the representation,
ii. Defining of the longest eigenvector as the direction of the extension line,
iii. Defining of the length of the representation along the longest eigenvector as the length of the extension line.

12. Method according to claim 4, wherein the defining of the extension line in step a. contains the following steps:
i. Determining of the eigenvectors of the representation,
ii. Defining of the longest eigenvector as the direction of the extension line,
iii. Defining of the length of the representation along the longest eigenvector as the length of the extension line.

13. Method according to claim 2, wherein the defining of the extension line in step a. contains the following steps:
a.i. Determining of features in the representation,
a.ii. Generating of a two-dimensional point cloud by projecting of points, on which
features are located, onto an extension projection plane,
a.iii. Forming of a graph that runs along the point cloud generated in a.ii.,
a.iv. Defining the graph generated in a.iii. as an extension line.

14. Method according to claim 3, wherein the defining of the extension line in step a. contains the following steps:
a.i. Determining of features in the representation,
a.ii. Generating of a two-dimensional point cloud by projecting of points, on which
features are located, onto an extension projection plane,
a.iii. Forming of a graph that runs along the point cloud generated in a.ii.,
a.iv. Defining the graph generated in a.iii. as an extension line.

15. Method according to claim 4, wherein the defining of the extension line in step a. contains the following steps:
a.i. Determining of features in the representation,
a.ii. Generating of a two-dimensional point cloud by projecting of points, on which
features are located, onto an extension projection plane,
a.iii. Forming of a graph that runs along the point cloud generated in a.ii.,
a.iv. Defining the graph generated in a.iii. as an extension line.

16. Method according to claim 1, wherein the represented objects are teeth and wherein the representation depicts at least three succeeding teeth.

17. Method according to claim 2, wherein the represented objects are teeth and wherein the representation depicts at least two, succeeding teeth.

18. Method according to claim 3, wherein the represented objects are teeth and wherein the representation depicts at least two, succeeding teeth.

19. Method according to claim 4, wherein the represented objects are teeth and wherein the representation depicts at least two, succeeding teeth.

20. Method according to claim 5, wherein the represented objects are teeth and wherein the representation depicts at least two, succeeding teeth.
